(19) United States
(12) Patent Application Publication
(10) Pub. No.: US 2006/0181775 A1
(43) Pub. Date: Aug. 17, 2006

(54) Optical imaging system with foil based laser/led modulator array

(75) Inventors: Oscar Hendrikus Willemsen, Eindhoven (NL); Siebe Tjerk De Zwart, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/564,916

(22) PCT Filed: Jul. 14, 2004
(86) PCT No.: PCT/IB04/51220

§ 371 Date: Jan. 17, 2006

(30) Foreign Application Priority Data
Jul. 17, 2003 (EP) 03102211.4

(51) Int. Cl. G02B 27/10

(52) U.S. Cl. 359/618

(57) ABSTRACT

The present invention relates to an optical imaging system. The system comprises at least one light source for producing at least one light beam (10). Beam shaping optics (11) arranged to expand the at least one light beam (10) in one direction. At le',ast one one-dimensional array of beam switches (1) is arranged to receive the expanded at least one light beam (10) and modulate it to form a line image. A projection lens (12) is provided for projecting said line image. A slow mirror scanner (13) is arranged to scan consecutive line images to form a two-dimensional image.

### BACKGROUND OF THE INVENTION

1. Field of the Invention

The present patent application relates to the field of LED or laser based display devices, and particularly to an optical imaging system comprising a scanning device for LED or laser based displays.

2. Description of the Related Art

One of the options to realize a small handheld projector type display is to use (diode) laser light sources in combination with a scanning/modulating device. A relatively simple embodiment could comprise three (RGB: Red, Green, Blue) laser diodes and a fast electromechanical mirror scanner. For such a device the diodes must be intensity modulated at frequencies of typically 10 MHz. The presently available red and blue lasers meet this requirement. A complication arises with the green lasers. They consist of an IR diode laser which pumps a frequency doubled YAG (yttrium-aluminum-garnet) laser. The maximum switching frequency of the YAG laser is limited to about 3 kHz. This hampers the realization of a full color display with a mechanical scanner.

A different approach is to use a one dimensional array of individual beam switches (e.g. 500 individual beam switches). An example of such an array which has been demonstrated by Silicon Light Machines is the Grating Light Valve (GLV). This array is based on switchable MEMS (Micro-Electrical-Mechanical-System) gratings. A laser beam is projected onto the grating. The zero order diffracted light is blocked. The higher orders are collected and projected onto a screen. The switching speed combined with the multiplicity of switches is sufficient for video projection. A drawback of the GLV is that the mechanical details are rather small (1-2 μm) and that the projection optics must be focused on the projection screen. The latter is due to the fact that the light leaves the grating under different angles and must be properly recollected on the screen by the imaging optics.

Another type of light switch is based on the well known fact that light travels at different speeds in different materials. Change of speed results in refraction. The relative refractive index between two materials is given by the speed of an incident light ray divided by the speed of the refracted ray. If the relative refractive index is less than one, as is the case e.g. when a ray of light passes from a glass block to air, then the ray of light will be refracted towards the surface. Angles of incidence and reflection are normally measured from a direction normal to the interface. At a particular angle of incidence “i” the refraction angle “r,” becomes 90° as the light runs along the surface of the glass block. The critical angle “i” can be calculated as “sin i=relative refractive index”. If “i” is made even larger, then all of the light is reflected back inside the glass block. This phenomenon is called total internal reflection. Because refraction only occurs when light changes speed, the incident radiation emerges slightly before being totally internally reflected, and hence a slight penetration (roughly one micron) of the interface occurs. This phenomena is called “evanescent wave penetration”. By interfering with (i.e. scattering and/or absorbing) the evanescent wave it is possible to prevent (i.e. frustrate) the total internal reflection phenomena.

An optical switch based on this phenomenon is described in WO 0137627 which relates to an optical switch for controllably switching an interface between a reflective state in which incident light undergoes total internal reflection and a non-reflective state in which total internal reflection is prevented. In one such switch an elastomeric dielectric has a stiffened surface portion. An applied voltage moves the stiffened surface portion into optical contact with the interface, producing the non-reflective state. In the absence of a voltage the separator moves the stiffened surface portion away from optical contact with the interface, producing the reflective state.

A drawback of the above described switch according to WO 0137627 is that a separator is positioned between the interface and the stiffened surface portion, which separator is likely to give rise to unwanted reflections giving rise to unwanted light at a screen if used in a projection system, thus decreasing the quality of the resulting image.

### SUMMARY OF THE INVENTION

Taking the above into mind, it is an object of the present invention to provide an improved optical imaging system comprising a scanning device for LED or laser based displays, by which an image can be projected onto a screen with a large depth of focus.

This object is achieved in accordance with the characterizing portion of claim 1.

Thanks to the provision of at least one laser or LED light source for producing at least one light beam; beam shaping optics arranged to expand said at least one light beam in one direction; at least one one-dimensional array of beam switches arranged to receive said expanded at least one light beam and modulate it to form a line image; a projection lens for projecting said line image; and a slow mirror scanner arranged to scan consecutive said line images to form a two-dimensional image a projection system that projects pixels onto a screen with a large depth of focus can be achieved.

Preferred embodiments are listed in the dependent claims.

### BRIEF DESCRIPTION OF THE DRAWINGS

In the drawings, wherein like reference characters denote similar elements throughout the several views:

FIG. 1 discloses a schematic illustration of a single switch in an “on” state;

FIG. 2 discloses a schematic illustration of the switch according to FIG. 1 in an “off” state rest position of the switch;

FIG. 3a illustrates schematically a one-dimensional array built up of beam switches according to FIG. 1;

FIG. 3b illustrates a side view of a one-dimensional array of beam switches according to FIG. 3a;

FIG. 3c illustrates a top view of a one-dimensional array of beam switches according to FIG. 3a;

FIG. 4a schematically shows the situation at the glass-vacuum interface of the switch according to FIG. 1;

FIG. 4b schematically shows the situation at the glass-foil interface of the switch according to FIG. 2;

FIG. 5 shows an example of an addressing scheme of a one-dimensional array of beam switches according to FIG. 3;

FIG. 6a shows in a top view an example of an optical imaging system containing the one-dimensional array of beam switches according to FIG. 3;

FIG. 6b shows in a side view the optical imaging system according to FIG. 6a;

FIGS. 7a and 7b discloses a beam switch device in “multi-pass” mode where the light passes two consecutive beam switches;

FIGS. 8a and 8b discloses a beam switch device in “multi-pass” mode where the light passes twice through one single beam switch returned by a mirror;

FIG. 9 discloses schematically a side view of a two-dimensional beam switch device;

FIG. 10 discloses a first embodiment of an optical imaging system that generates full color images with a one-dimensional array of foil based beam switch modulators;

FIG. 11 discloses a second embodiment of an optical imaging system that generates full color images with a one-dimensional array of foil based beam switch modulators;

FIG. 12 discloses a third embodiment of an optical imaging system that generates full color images with a one-dimensional array of foil based beam switch modulators;

FIG. 13 discloses an illustration of a different type of prism which can be used with the beam switch;

FIG. 14 discloses a top view of an optical imaging system as in FIG. 6 having a polarizing element in the detection path.

Still other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### DETAILED DESCRIPTION OF THE PRESENTLY PREFERRED EMBODIMENTS

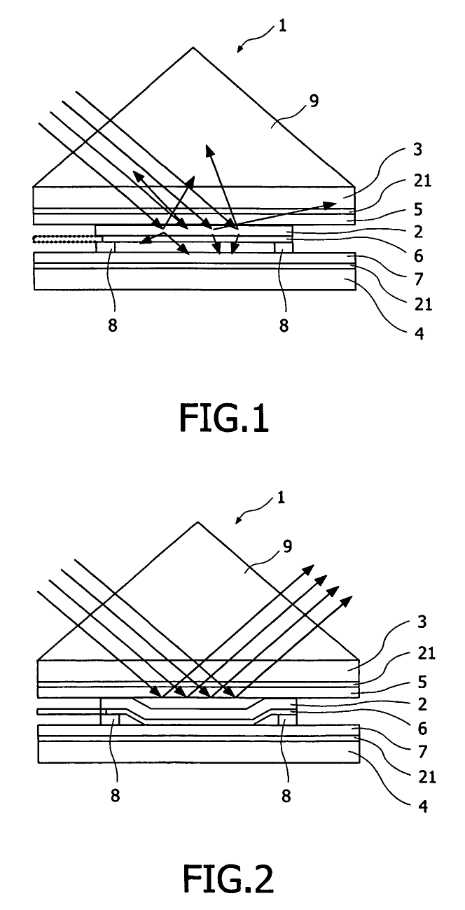

An optical imaging system utilizing at least one one-dimensional array of beam switches 1 based on the principle of frustrated total internal reflection to generate a projected image is envisaged. FIG. 1 shows a schematic illustration of a single beam switch 1, i.e. one pixel of the array. The beam switch 1 consists of a scattering foil 2 which is sandwiched between a first 3 and a second 4 glass plate, at least the upper one (first glass plate 3) being transparent for light from a light source. The scattering foil 2 and the glass plates 3, 4 are equipped with electrodes. The upper (first) glass plate 3 is coated with a first transparent electrode 5 (e.g. ITO, Indium-Tin-Oxide) and the scattering foil 2 is coated with a transparent foil electrode 6, the lower (second) glass plate 4 can be covered with a non-transparent second electrode 7. The scattering foil 2 is separated from at least one of the glass plates 3, 4 by means of spacers 8. The scattering foil 2 can be actuated by applying proper voltages to the respective electrodes 5, 6, 7. Light from the light source is coupled into the beam switch 1 by means of a prism 9. If the scattering foil 2 is not in contact with the first glass plate 3 the light is reflected from the glass surface by total internal reflection. If the scattering foil 2 is brought into contact with the first glass plate 3 the light is scattered. This is schematically shown in FIG. 2, which illustrates the rest position of the switch 1. The switching device 1 might be integrated directly upon the surface of a driver chip.

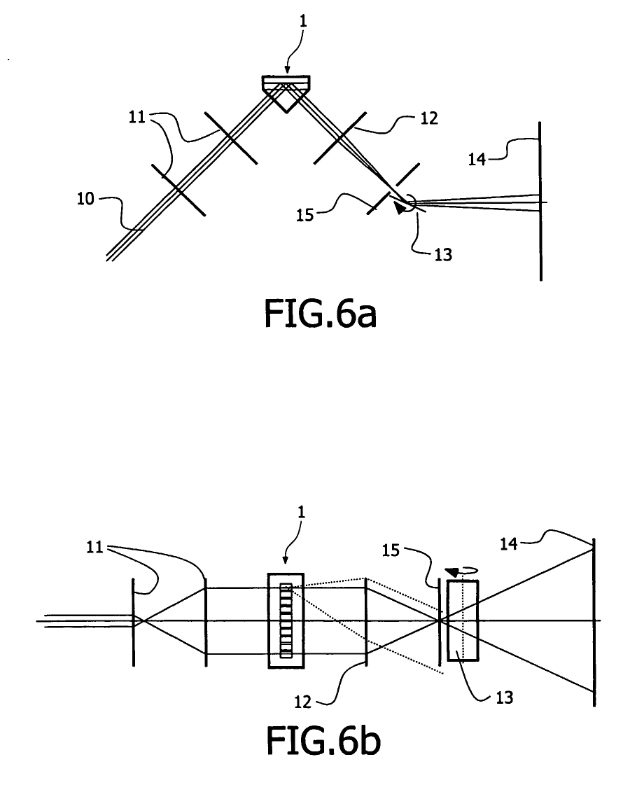

When the pixel is in the “on” state (FIG. 1) the scattering foil 2 is drawn to the lower (second) glass plate 4 by applying the proper voltages to the electrodes 5, 6, 7. Since the incident angle on the glass-air interface is larger than the critical angle, all light is reflected. When the pixel is in the “off” state (FIG. 2), the scattering foil 2 is drawn to the front (first) glass plate 3, i.e. to the rest position of the switch 1. Using light with the proper polarization direction, all can be coupled into the scattering foil 2, in which it is scattered in all directions. The specularly reflected light is separated from the scattered light with the optical imaging system that is illustrated in FIG. 6. The optical imaging system consists of a laser or LED light source (not shown) for producing a light beam 10, beam shaping optics 11, e.g. two cylindrical lenses, arranged to expand the light beam 10 in one direction, a one-dimensional array of beam switches 1 arranged to receive the expanded light beam 10 and modulate it to form a line image, a projection lens 12 for projecting said line image and a scan mirror 13 arranged to scan consecutive line images to form a two-dimensional image. The expanded light beam 10 can be selectively scattered or reflected by each of the beam switches 1. In this way a bar line image of separately modulating light sources is created that is scanned with a scanner 13 that is operated at the same frequency. Finally, the projection lens 12 images the scanning light bar onto a screen 14.

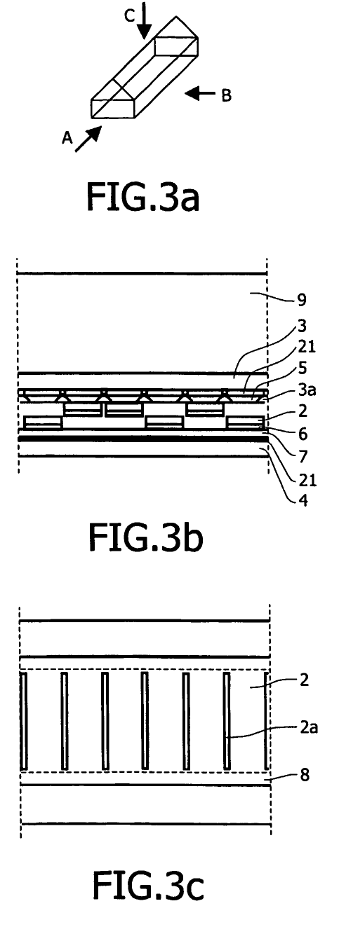

FIG. 3a schematically shows an example of a one-dimensional array of beam switches. In this particular embodiment the scattering foil 2 is cut to facilitate the use of beam switches 1 which are small in the direction A along the array (typically 300 μm between the cuts). In the other direction B the beam switches 1 may be relatively large (typically 300 μm) to lower the required switching voltages. The structured front plate electrodes 5 (typically 50 μm) are used to address the device. The foil electrode 6 and the rear plate second electrode 7 are basically unstructured. The front (first) glass plate 3 area above the cuts have been made scattering, or has been coated with a scattering medium 3a. The cuts 2a in the foil 2 are not a prerequisite, they merely serve to lower the switching voltages and reduce crosstalk. Instead of, or in addition to, structuring the front (first) glass plate electrodes 5 for addressing, it is also possible to structure the foil electrode 6 or the rear (second) glass plate electrode 7. The foil electrode 6 may be applied to either side, or to both sides, of the scattering foil 2. The spacers 8 may be applied on top or underneath the dielectric layer 21, or may be omitted, partly or fully. In a preferred embodiment, spacers 8 are arranged only on the rear (second) glass plate 4, which is made possible as the scattering foil 2 is thin and arranged to be in contact with the front (first) glass plate 3 in its rest condition and in order to be pulled away therefrom needs to be actuated with an electric field. Through, in the preferred embodiment, having spacers 8 arranged only on the rear (second) glass plate 4 the advantage is provided that they cannot reflect light which would give rise to unwanted light on the screen. If the scattering foil 2 is coated with a conductor at only one side the dielectric layer 21 at the opposite side may be omitted. The scattering foil 2 is preferably diffusely scattering, e.g. due to the addition of small particles to a polymer or inorganic matrix, or it may alternatively be equipped with regular diffractive structures such as a diffraction grating. The spaces between the scattering foil 2 and the glass plates 3, 4 can be filled with any gas or can be made vacuum.

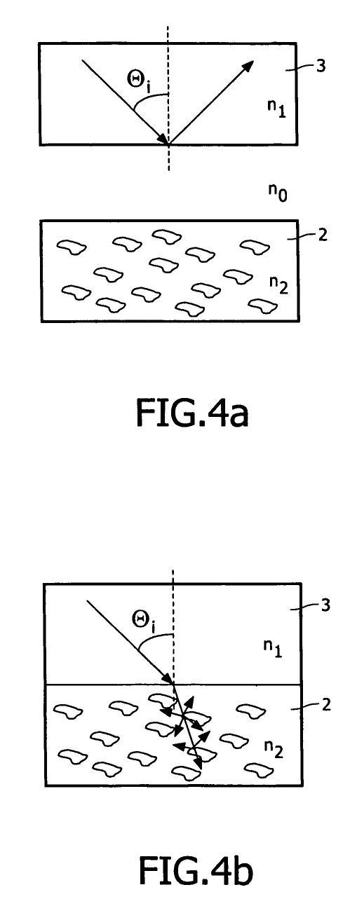

For optimum performance the polarization of the light and the angle of incidence have preferred values. FIG. 4a schematically shows the situation at the glass-vacuum interface and FIG. 4b the situation at the glass-foil interface. For simplicity the transparent electrodes and the dielectric layer 21 have been omitted. In order to have total internal reflection at the glass-vacuum interface (“on” state), the angle of incidence Θᵢ should be larger than the critical angle Θ_{crit} given by:

$$sin ( {Θ}_{crit} ) = \frac{{n}_{0}}{{n}_{1}}$$

With n₀=1 (vacuum) and n₁=1.5 (typical for glass) this yields Θ_{crit}=41.8°. If the scattering foil 2 makes contact with the glass 3 (“off” state) it is desired that little or no light is reflected from the interface and that all the light penetrates into the scattering foil 2. In the ideal case this happens if the polarization of the light is parallel to the plane of incidence/reflection (p-polarized) and if the angle of incidence is equal to the Brewster angle Θ_{brew}, given by:

$$tan ( {Θ}_{brew} ) = \frac{{n}_{2}}{{n}_{1}}$$

With n₁=1.5 and n_{2=1.65} (typical for a polymer foil) this yields Θ_{brew}=47.7°. Hence, both conditions of total internal reflection in the “on” state and minimum reflection (from the interface) in the “off” state can be met if the light is p-polarized and the angle of incidence equals the Brewster angle. In the case of presence of a transparent conductor and a dielectric layer 21 on the glass 3, the situation becomes more complicated and a detailed analysis remains to be done. In an actual device, a preference for p-polarized light has been experimentally observed.

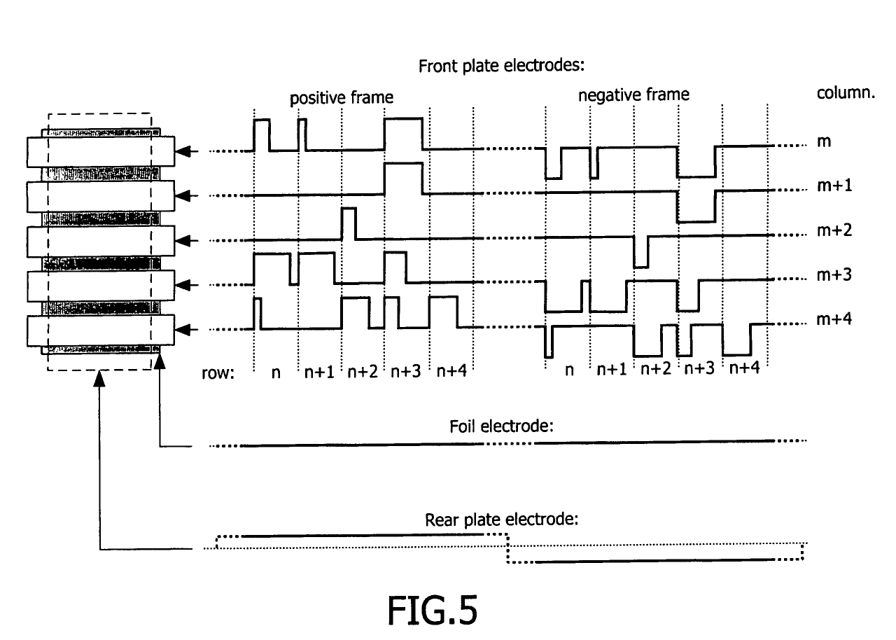

FIG. 5 shows an example of an addressing scheme. In this case the information is written (line- or column-at-a-time) using pulse width modulation. The foil electrode 6 is at ground potential. The voltage on the rear (second) glass plate electrode 7 (typically 30V amplitude) is inverted in between the frames to avoid charging. If the voltage on the addressing is high (typically 60V) in the positive frame (or low in the negative frame) the scattering foil 2 is attracted towards the front (first) glass plate 3. If the voltage on the addressing electrode is zero, the scattering foil 2 is attracted towards the back (second) glass plate 4. The details of the addressing scheme strongly depend on the mechanical details, like foil thickness, dielectric layer thickness, spacer thickness, etc. As mentioned, the addressing electrodes 5, 6, 7 may alternatively be structured on the scattering foil 2 or the rear (second) glass plate 4. In that case different addressing schemes apply.

FIGS. 6a and 6b shows an example of an optical imaging system containing the one-dimensional array of beam switches 1. A light beam 10 is expanded in one direction using beam shaping optics II composed of two cylindrical lenses to illuminate the array of beam switches 1, which is arranged to receive the expanded light beam and modulate it to form a line image. After passing the array of beam switches the beam of reflected light from the “on” state is led through a projection lens 12 and a pinhole diaphragm 15. The beam switches 1 and the pinhole diaphragm 15 are placed approximately in the focal planes of the projection lens. The light from beam switch pixels in the “on” state passes the pinhole diaphragm 15 and is projected on the screen 14. In the “off” state the light is scattered in all directions and only a very small portion will enter the projection lens 12. The scattered light from beam switch pixels in the “off state” is intercepted either by the projection lens 12 aperture or, if passing that aperture, by the pinhole diaphragm 15 aperture. The result is a vertical (or horizontal) modulated bar line image on the screen. This line image bar can be scanned to form a two-dimensional image by using a slow mirror scanner 13. In the case of a laser light source, the depth of focus is very large, in the ideal case indefinitely large. Since the distance between beam switches 1 and the projection lens 12 is almost equal to the focal length of the projection lens 12, the image is focused almost at infinity. If a lower quality light source is used, the system must be properly focused on the screen 14, i.e. meaning that the distance between beam switches 1 and projection lens 12 must be adapted. The switching speed of the foil based beam switch device 1 is sufficiently high for video modulation. The efficiency for pixels in the “on” state is close to 100%.

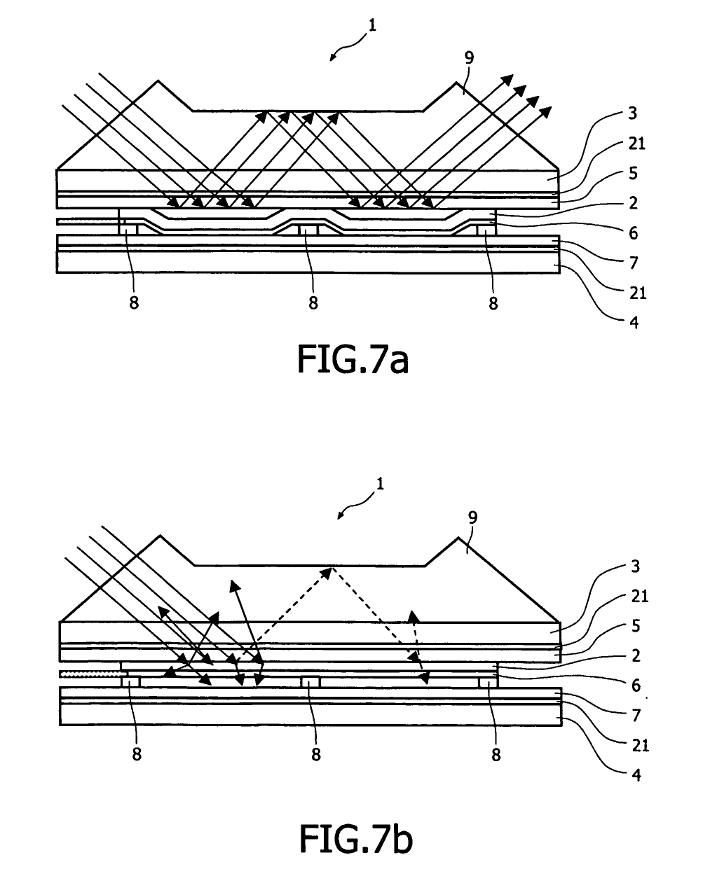

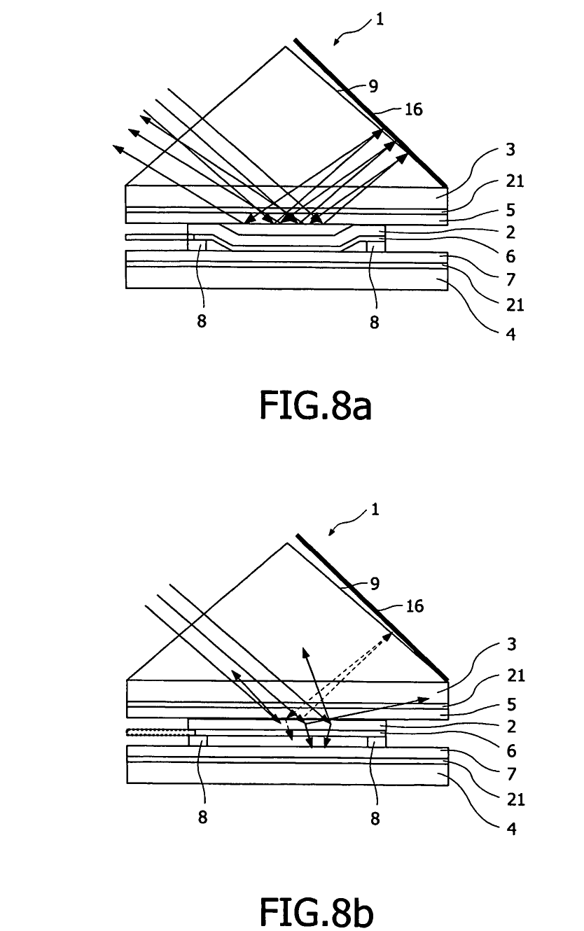

The contrast that can be obtained with this type of beam switch 1 depends on many parameters: The angel of incidence, polarization of the incident light, “parasitic” reflections by electrodes/spacers/layers, optical properties of the scattering foil, design of the surrounding optical system, . . . etc. In an experimental device a contrast of 1:44 has been obtained, it is however believed that this can be optimized further. One rigorous way of improving the contrast is to use a beam switch device 1 in “multi-pass” mode. Examples are shown in FIGS. 7a and 7b and 8a and 8b respectively. In FIGS. 7a and 7b the light passes two beam switches 1, which are operated simultaneously. In the “off” state according to FIG. 7b, some light will be specularly reflected from the first beam switch, but this will be further “extinguished” by the second beam switch. Except for improving contrast, the use of two or more sequential beam switches is very beneficial for overcoming imperfections in the scattering foil 2 (particles and related non-contact areas). In FIGS. 8a and 8b one single beam switch 1 is used twice. A mirror 16 is positioned such that the returning beam leaves the beam switch device under a (slightly) different angle in order to be able to separate it from the incoming beam. Instead of a simple flat mirror one may also use a more complicated imaging system (lenses, curved mirrors, retro-reflectors, . . . etc.) to redirect and re-image the beams onto the device.

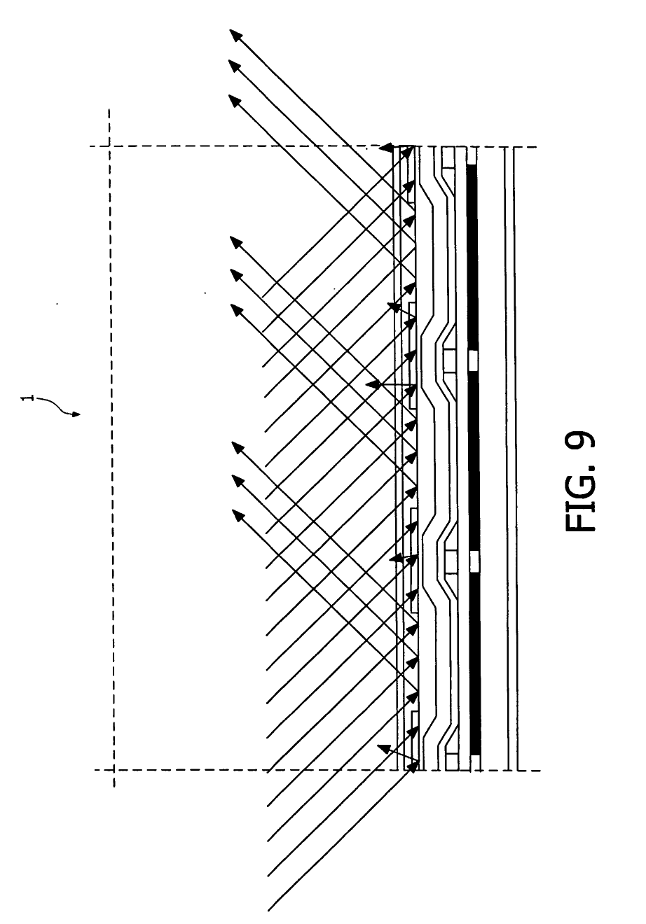

Instead of a one-dimensional projection device, one could also imagine a two-dimensional beam switch device 1 as shown in FIG. 9. In this case an electrode matrix structure is necessary. The spacers (if present in the optical path) should be shielded by a diffusive medium. This embodiment is mentioned only for completeness. One of the issues in using a two-dimensional device is that the operating window for passive matrix addressing is rather small and very sensitive to e.g. charging effects. For a one-dimensional array, a simple and “robust” switching scheme can be used, reducing the fraction of failing pixels.

The beam switch as described herein is in fact based on “optical quality” or “entendue” selection. For this reason a preferred light source to be used is a laser. However, present day lasers are not efficient in green, and the image obtained with lasers also suffers from speckle. For this reason, LED's are an attractive alternative, although probably some light will have to be disposed due to entendue requirements.

An actual optical imaging system display device should reproduce an image using at least three (primary) colors, e.g. Red, Green and Blue. There are many options to achieve this: e.g. one array and line sequential color, one array and frame sequential color, one array and scrolling color, three (or more) arrays and simultaneous color, . . . etc. Detailed embodiments concerning color and grayscale reproduction will be described in the following.

In the following is described a number of embodiments of optical imaging systems that generates full color images with a one-dimensional array of foil based beam switch modulators 1 as described earlier. The embodiments have a number of conditions in common that are listed below:

The light is generated in three separate branches R, G, B that each include a one-dimensional array of foil based beam switch modulators 1;

The light path in each of the branches R, G, B is optimized for transmission of the color of light in that particular branch;

The arrays of foil based beam switch modulators 1 are positioned such that they lie in the same plane when seen from the direction of the projection lens 12;

The projection lens 12 images the glass-foil interface of the foil based beam switch modulators 1 onto the screen 14;

A diaphragm 15 is positioned at the focal plane of the projection lens 12 and between the projection lens 12 and a rotation mirror 13.

The details of these conditions will be given below.

Embodiment one: architecture with a dichroic recombination cube 17.

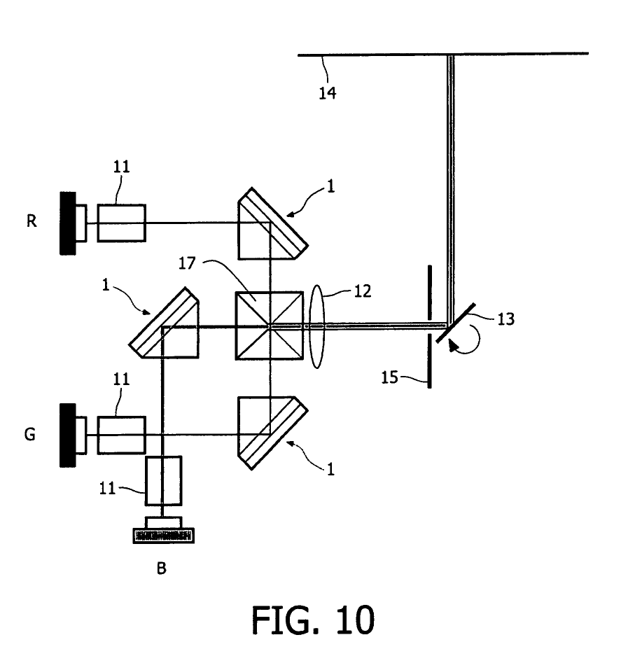

The first embodiment is illustrated in FIG. 10. In this set-up the array of foil based beam switch modulators 1 is the same as the one depicted in FIG. 6.

In the set-up the light is formed in three branches R, G, B, each of them corresponding to one of the display primaries. The optical elements in the branches R, G, B are optimized for the wavelength that is used in the branches. For instance, the beam shaping optics 11 that takes care that a thin line of parallel light illuminates the beam switches 1 is covered with antireflection coatings that are optimized for the red laser beam. The light in the three branches R, G, B is recombined with a dichroic cube 17. The position of the three foil array blocks 1 is such that they are in the same plane, when viewed from the direction of the projection lens 12. The projection lens 12 is positioned such that it images the glass-foil interface of all three array panels 1 onto the screen 14. A diaphragm 15 is positioned at the focal plane of the projection lens 12 and the rotating mirror 13 to enhance the contrast.

Note that the dichroic cube 17 can be quite small in the direction of the plane of FIG. 10, since the light from the foil based beam switch array 1 is almost parallel in the case of a laser light source. Only in the direction perpendicular to this plane the cube 17 needs to be elongated as long as the length of the foil based beam switch array 1. This makes the dichroic cube 17 much cheaper than the ones used in HTPS LCD projectors.

Embodiment two; architecture with dichroic recombination plates 18.

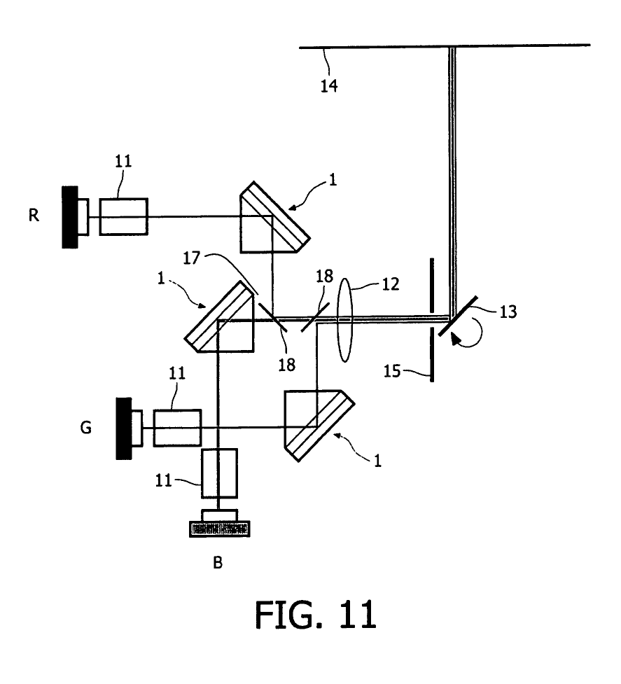

A second embodiment is illustrated in FIG. 11. The main difference from the first embodiment according to FIG. 10 is that dichroic plates 18 have been used instead of a dichroic recombination cube 17. This has some consequences for the folding of the light path, which can be observed from FIG. 11.

Embodiment three; architecture with folding mirror 19.

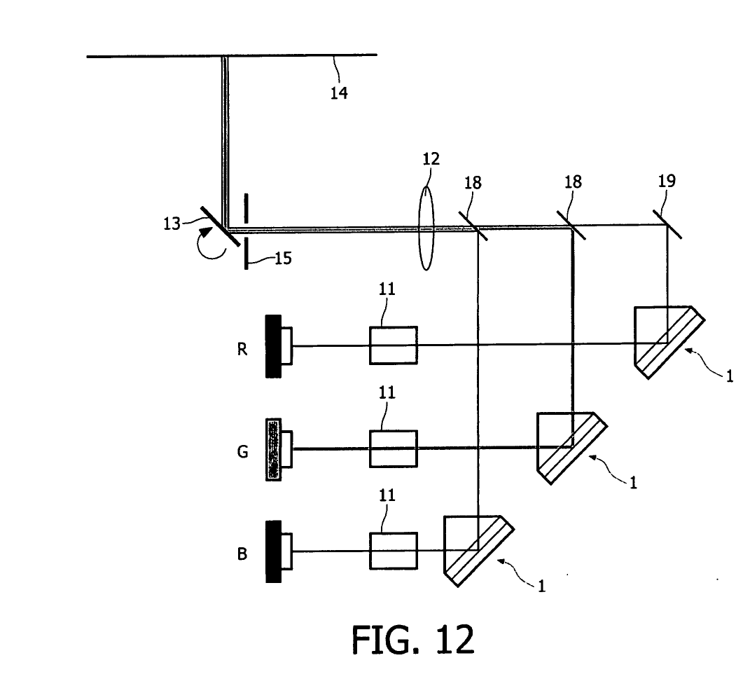

A third embodiment is illustrated in FIG. 12. When compared to embodiment two (FIG. 11) it uses an extra folding mirror 19. Although this adds to the bill of material it also has some advantages. First, the three foil based beam switch arrays 1 can be positioned in one plane. Although drawn separately in FIG. 12, they can be combined onto a single glass plate. This can be beneficial for manufacturing and it offers an automatic alignment of the three foil based beam switch arrays 1. Second, the illumination path of the three foil based beam switch arrays 1 is parallel. This enables the combination of optical components into one piece of material. Third, the beam path is folded, which results in a very compact device.

General remarks for the three embodiments described above.

Since all proposed optical paths R, G, B are chosen such that the three beams overlap on the screen, the light path of the individual colors can be interchanged.

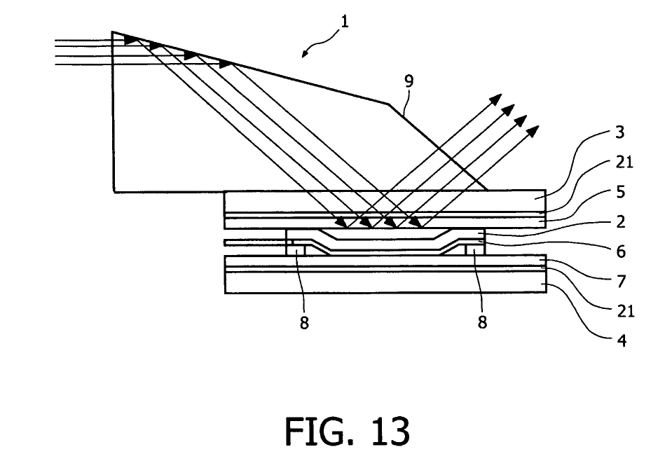

In all of the above embodiments the light is coupled into the foil based beam switch arrays 1 by means of a 90-degree prism 9. A person skilled in the art can easily find other prisms to couple in the light. As an illustration of a different type of prism 9 is shown in FIG. 13. With such a prism 9 it is easy to find similar embodiments than the ones proposed, but then with a different folding of the light path. This is also included in the invention.

If the light is generated in a laser, it is usually already polarized. By taking care that all optical components are free of internal stresses, the light will maintain its polarization direction until the glass-foil interface. If the pixel is in the “on” state, the light will be reflected internally without losing its polarization properties. If the pixel is in the “off” state, the light enters the scattering foil 2, in which it will be scattered a number of times before it leaves the foil 2. During each scatter event, both the direction and polarization state of a photon are changed by a small amount. Since each of the photons scatters in a different way, a contribution of polarization states will build up. For weakly scattering media, the width of the distribution will be small and centered around the original polarization direction. For strongly scattering media, such as a scattering foil 2 in the foil based array of beam switches 1, the distribution will be almost uniform.

Taking the above into consideration, it is clear that placing a polarizing element in the detection path will increase the contrast ratio of the displayed image. Assuming that the absorption coefficient of the element is A and that the extinction ration of the element is infinitesimal small. Further assuming that the polarization distribution of the scattered photons is completely uniform. In this case the following equations hold for the intensity of the “off” pixel B and the “on” pixel C:
B′=0.5·(1−A)·B
C″=(1−A)·c

In which B is the intensity of the “off” pixel without the polarizer and C is the intensity of the “on” pixel without the polarizer.

By dividing the two equations it is clear that the contrast ratio is increased by a factor of two. In practice this will probably be somewhat less due to the non-perfect polarizers and the non-uniform polarization distribution of the scattered photons. A negative side effect of the polarizer is that the intensity of the “on” pixels has decreased by the factor A. By choosing a polarizer with high transmission efficiency this can be limited to 10%.

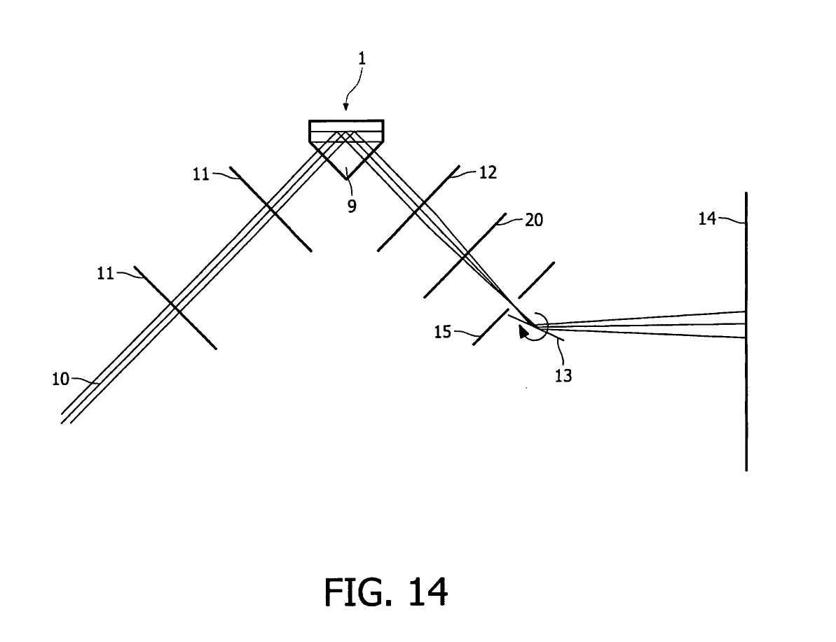

An embodiment of this is shown in FIG. 14. In principle the polarizer 20 can be positioned anywhere between the prism 9 and the screen 14. In practice, a choice will be made between size of the polarizer 20 and the maximum intensity that can be applied to the polarizer 20.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. An optical imaging system, characterized by:
(a) at least one laser or LED light source for producing at least one light beam (10);
(b) beam shaping optics (11) arranged to expand said at least one light beam (10) in one direction;
(c) at least one one-dimensional array of beam switches (1) arranged to receive said expanded at least one light beam (10) and modulate it to form a line image;
(d) a projection lens (12) for projecting said line image;
(e) a slow mirror scanner (13) arranged to scan consecutive said line images to form a two-dimensional image.

2. The optical imaging system of claim 1, characterized by:
said expanded at least one light beam (10) being arranged to pass sequentially through two one-dimensional arrays of beam switches (1) arranged to receive said expanded at least one light beam (10) and modulate it to form a line image, which two one-dimensional arrays of beam switches (1) are arranged to operate simultaneously.

3. The optical imaging system of claim 1, characterized by:
said expanded at least one light beam (10) being arranged to pass through a one-dimensional array of beam switches (1) arranged to receive said expanded at least one light beam (10) and modulate it to form a line image and being returned through the same array by a reflection mirror (16), said mirror (16) being arranged to return said beam (10) under an angle which is different from the angle of the angle of the incident light beam in order to facilitate separation there from.

4. The optical imaging system of any one of claims 1 to 3, characterized by:
(f) three separate laser or LED light sources for producing three separate light beams (10);
(g) beam shaping optics (11) arranged to expand each respective light beam (10) in one direction;
(h) a respective one-dimensional array of beam switches (1) arranged to receive each respective expanded light beam (10) and modulate it to form a respective line image;
(i) means for combining (17, 18, 19) said respective line images to one line image;
(j) a projection lens (12) for projecting said combined line image;
(k) a slow mirror scanner (13) arranged to scan consecutive said combined line images to form a two-dimensional image.

5. The optical imaging system of claim 4, characterized by said means for combining said respective line images to one line image being a dichrioc cube prism (17).

6. The optical imaging system of claim 4, characterized by said means for combining said respective line images to one line image being dichroic plate mirrors (18).

7. The optical imaging system of claim 4, characterized by said means for combining said respective line images to one line image being a combination of dichroic plate mirrors (18) and at least one folding mirror (19).

8. The optical imaging system of any one of the preceding claims, characterized by the at least one one-dimensional array of beam switches (1) comprising a plurality of optical beam switches for controllably switching an optical interface between a reflective state in which light incident on said optical interface undergoes frustrated total internal reflection and a non-reflective state in which frustrated total internal reflection is prevented at said optical interface.

9. The optical imaging system of claim 8, characterized by each of the plurality of beam switches (1) comprising:
(a) a scattering foil (2), which is sandwiched between a first (3) and a second (4) glass plate;
(b) a foil electrode (6) associated with said foil (2);
(c) a first transparent electrode (5) associated with said first glass plate (3);
(d) a second electrode (7) associated with said second glass plate (4);
(e) a voltage source for selectively applying voltage potentials to said electrodes (5, 6, 7); wherein:
(i) application of a first set of voltage potentials to said electrodes (5, 6, 7) is arranged to attract said foil (2) towards said first glass plate (3), in order to scatter light incident on said first glass plate (3);
(ii) application of a second set of voltage potentials to said electrodes (5, 6, 7) is arranged to attract said foil (2) away from said first glass plate (3), in order to allow light to be reflected from said first glass plate (3).

10. The optical imaging system of claim 9, characterized by said scattering foil (2) being separated from at least one of said glass plates (3, 4) by spacers (8).

11. The optical imaging system of claim 10, characterized by said spacers (8) being arranged between said scattering foil (2) and said second glass plate (4).

12. The optical imaging system of any one of claims 8 to 11, characterized by a prism (9) being arranged on said first glass plate (3), through which prism (9) light incident on said first glass plate (3) is arranged to pass.

13. The optical imaging system of any one of claims 8 to 12, characterized by a dielectric layer (21) being sandwiched between said first glass plate (3) and said first electrode (5).

14. The optical imaging system of any one of claims 8 to 13, characterized by a dielectric layer (21) being sandwiched between said second glass plate (4) and said second electrode (7).

15. The optical imaging system of any one of claims 8 to 14, characterized by said scattering foil (2) having cuts (2a) separating the foil of each respective beam switch of the at least one one-dimensional array of beam switches (1) from each other.

16. The optical imaging system of claim 15, characterized by a surface area of said first glass plate (3) being arranged to have light scattering properties (3a) above said cuts (2a).

17. The optical imaging system of any one of claims 8 to 16, characterized by said first glass plate (3) being common to all beam switches (1) of said at least one one-dimensional array of beam switches (1).

18. The optical imaging system of any one of the preceding claims, characterized by a diaphragm (15) being arranged in a light path of said optical imaging system, at a location after said projection lens (12).

19. The optical imaging system of any one of the preceding claims, characterized by a polarizer (20) being arranged in a light path of said optical imaging system, at a location after said one-dimensional array of beam switches (1).
